(19) United States
(12) Patent Application Publication
(10) Pub. No.: US 2021/0070536 A1
(43) Pub. Date: Mar. 11, 2021

(54) CAPSULES FOR CONTAINING COFFEE OR ANOTHER SUBSTANCE FROM WHICH A BEVERAGE CAN BE EXTRACTED USING HOT WATER

(71) Applicant: Euro-Caps Holding BV, Rotterdam (NL)

(72) Inventor: Anthony Kay, Cape Town (ZA)

(73) Assignee: Euro-Caps Holding BV, Rotterdam (NL)

(21) Appl. No.: 16/953,738

(22) Filed: Nov. 20, 2020

Related U.S. Application Data
(63) Continuation of application No. 15/578,142, filed on Nov. 29, 2017.

(30) Foreign Application Priority Data
May 29, 2015 (ZA) 2015/03858

(51) Int. Cl. B65D 85/804

(52) U.S. Cl. CPC B65D 85/8043

(57) ABSTRACT

A capsule for use in an extraction machine has a frustoconical side wall, a transverse base closing one end of the side wall, an open mouth at the end remote from the base and a peripheral flange encircling the open mouth. A section of the side wall of the capsule close to the flange is thicker than the remainder of the side wall.

### CROSS-REFERENCE TO RELATED APPLICATIONS

The present application is a continuation of U.S. patent application Ser. No. 15/578,142, filed Nov. 29, 2017, which is a 35 U.S.C. § 371 national stage entry of International patent application no. PCT/IB2016/052818, filed May 16, 2016, each of which is incorporated by reference herein in their entireties, and which claims priority to South African patent application no. 2015/03858, filed May 29, 2015.

### FIELD

The present application relates to capsules for containing coffee or another substance from which a beverage can be extracted using hot water, and extraction machine systems for use with such capsules.

### BACKGROUND

Capsules containing coffee are widely used with “Nespresso” coffee extraction machines. “Nespresso” is the registered trademark of Nestle.

The capsules have a frustoconical body which has a transverse base at the smaller diameter end and an open mouth at the larger diameter end. After the capsule is filled, it is closed by a foil which is bonded to a flange which encircles the mouth of the capsule.

The extraction machine includes a sleeve the free end of which, as the machine is closed for the purposes of extraction, presses on the face of the flange opposite that to which the foil is secured. Pins inside the sleeve penetrate the base of the capsule as the machine closes.

Hot water is forced into the sleeve and this flows into the capsule between the outer surfaces of the pins and the edges of the holes that the pins have made.

The foil is pressed against a grid. When sufficient pressure has been created in the capsule, the foil bursts and a plurality of minute holes are formed in it through which the extracted beverage flows.

Another form of capsule is shorter than the capsule described above. This capsule is too short for the pins to reach it. Its base is in the form of a fine mesh through which the hot water in the sleeve enters the capsule.

In both forms of capsule it is essential that water not be able to leak between the flange of the capsule and the end of the pressing sleeve which is forced against the flange.

Many forms of sealing structures have been proposed for the purpose of ensuring that there is a seal between the flange and the pressing sleeve which provides sufficient assurance that leakage will not take place. In practice there is some leakage but provided this is restricted to, say, less than 3 or 4 ml, it is acceptable. If excessive leakage does take place the requisite pressure to puncture the foil is not achieved. In this event a “short shot” may be delivered or water may be delivered to the cup before any coffee is delivered resulting in a weak beverage or no coffee at all may be delivered.

The disclosed technology provides a sealing structure for a capsule which provides reliable sealing without the necessity of complex arrangements of ribs on the surface of the flange which faces the pressing sleeve.

### SUMMARY

According to one or more embodiments of the disclosed technology, there is provided a capsule for use in an extraction machine, the capsule having a frusto-conical side wall, a transverse base closing the smaller end of the capsule, an open mouth at the end of the capsule remote from the base and a peripheral flange encircling the open mouth of the capsule, characterized in that the side wall of the capsule is thickest over that section thereof which is closest to the flange, there being a single circumferentially extending sealing rib protruding from said flange in the direction towards the smaller end of the capsule and a circumferentially extending channel between said rib and said section.

In one form the outer surface of the capsule's wall has a first step in it at which the conical angle increases and a second step spaced axially towards the flange from the first step at which the conical angle decreases thereby to form a shoulder between said steps which has a circumferentially extending skew surface. In this form the outer surface of the capsule is cylindrical between the skew surface and the flange. Further, in this form, there can be a circumferentially extending sealing rib protruding from said flange in the direction towards the smaller end of the capsule, the rib being of triangular cross section with its base integral with the flange and having an apex which, in use, is crushed by the leading end of the pressing sleeve.

In a further form the conical angle of the outer surface of the side wall, over said section, is greater than the conical angle of the inner surface of said side wall over said section whereby said inner and outer surfaces diverge in the direction towards the flange and the wall thickness increases in the direction towards the flange.

In this further form there can be a circumferentially extending sealing rib protruding from said flange in the direction towards the smaller end of the capsule, there being a circumferentially extending generally U-shaped channel between said rib and said section for receiving the leading end of the pressing sleeve.

### BRIEF DESCRIPTION OF THE DRAWINGS

For a better understanding of the disclosed technology, and to show how the same may be carried into effect, reference will now be made, by way of example, to the accompanying drawings in which:

FIG. 1 is an axial section through a capsule in accordance with the disclosed technology;

FIG. 2 is a radial section showing the relationship between the pressing sleeve of an extraction machine and the sealing structure of a capsule before the sleeve reaches the end of its travel towards the flange;

FIG. 3 is a radial section showing the relationship between the pressing sleeve and the sealing structure when the sleeve is at the end of its travel;

FIG. 4 is a section showing the pressing sleeve of a coffee extraction machine and a further form of capsule before the sleeve reaches the end of its travel; and

FIG. 5 is a section to a large scale illustrating the sealing zones which are created between the capsule and the pressing sleeve.

### DETAILED DESCRIPTION

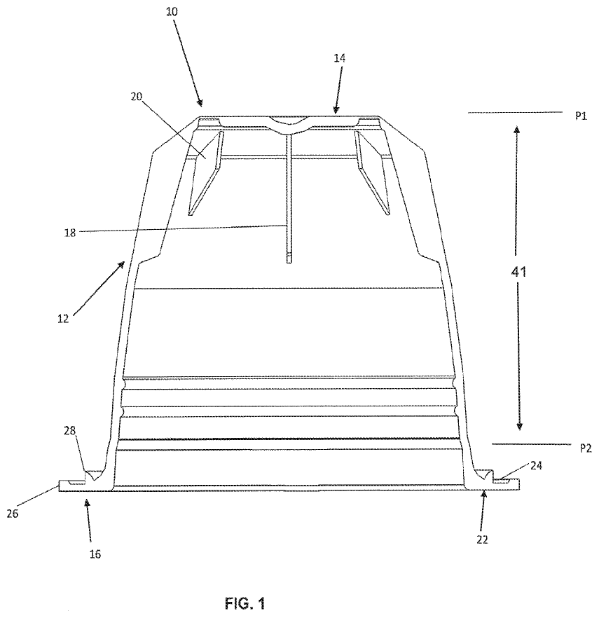

The capsule shown in FIG. 1 is designated 10 and includes a frusto-conical body 12, a transverse base 14 at the smaller end of the body 12 and a flange 16 at the wider, open end of the body 12. Long internal strengthening ribs 18 and short internal strengthening ribs 20 are provided in the angle between the body 12 and the base 14.

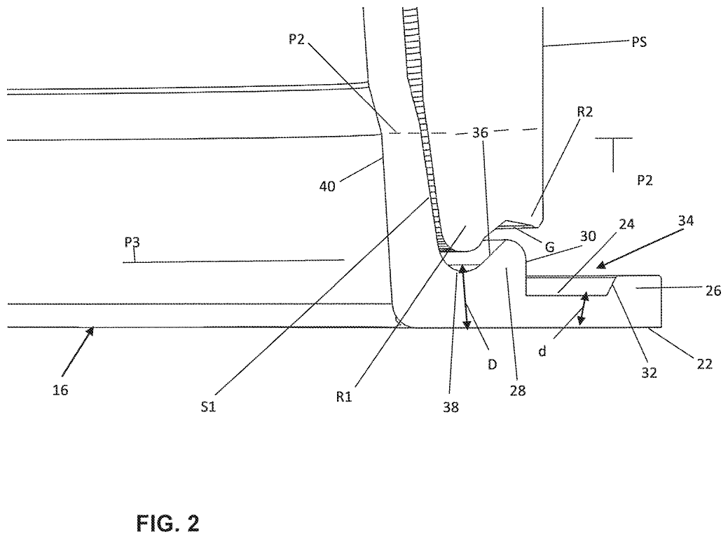

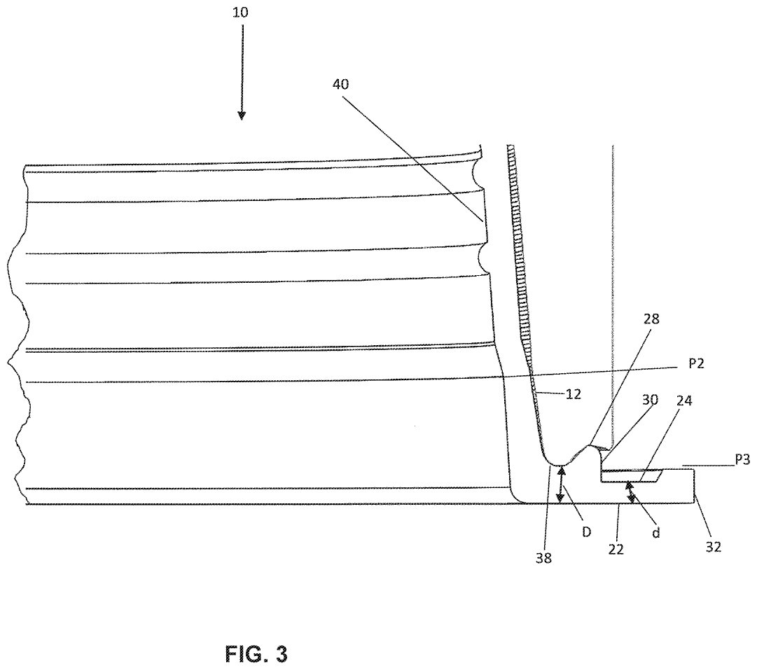

The flange 16, see particularly FIGS. 2 and 3, has a planar annular surface 22 which faces away from the smaller end of the body 12. The opposite surface of the flange 16 is designated 24. A bead 26 extends around the periphery of the flange 16 and protrudes above the surface 24 when the capsule is orientated as shown, that is, with its wide end lowermost. The bead 26 is provided for strengthening purposes and inhibits flexing of the thin flange 16.

A sealing rib 28 is provided which protrudes above the surface 24 when the capsule is orientated as shown.

The rib 28 has a radially outer flat flank 30. Between the flank 30 and the radially inner flank 32 of the bead 26 there is a circular channel 34 which extends around the body 12. If the pressing sleeve is of the type which includes a sealing ring, this enters the channel 34 during extraction.

The radially inner flank of the rib 28 is designated 36 and slopes radially inwardly from the apex of the rib 28.

The flank 30 is of greater height, measured in the direction parallel to the longitudinal axis of the body 12, than the flank 36. The thickness “d” (FIG. 2) of the flange 16 between the surfaces 22 and 24 is consequently less than the thickness “D” of the flange between the surface 22 and the bottom of a U-section channel 38 which is defined between the body 12 and the rib 28.

The wall 40 of the body 12 is not of uniform conical angle throughout its axial length from the base 14 to the flange 16. The angle changes a number of times over the section 41 of the wall 40 which lies between the planes P1 and P2 (FIG. 1).

Over the section 41 the conical angles of the inner and outer surfaces of the wall 40 change in the same way. Hence the wall thickness remains the same.

At plane P2 the conical angle of the inner surface of the wall 40 and of the outer surface of the wall 40 both change as best seen in FIGS. 2 and 3. Over the wall section between the plane P2 and the plane P3, which is coincident with the beginning of the radially outer flank of the channel 38, the conical angle of the inner surface of the wall 40 differs from the conical angle of the outer surface.

The conical angle of the outer surface of the wall 40 over the section closest to the flange is greater than the conical angle of the inner surface of the wall 40. Hence from the plane P2 to the plane P3 the wall thickness steadily increases. The maximum wall thickness is where the outer surface of the wall 40 curves outwardly to become the radially inner bounding flank of the channel 38.

The shape of the leading end of the pressing sleeve PS can be seen in FIGS. 2 and 3. In radial section it has a radially inner frusto-conical surface S1, a rounded circumferentially extending protrusion R1, a radially outer, circumferentially extending protrusion R2 and a circumferentially extending groove G between the protrusions R1 and R2.

As the leading end of the sleeve PS moves towards the sealing structure of the capsule, its inner surface S1 approaches the outer surface of the thicker part of the wall 40 of the capsule 10 (see FIG. 2).

During the last part of the movement of the sleeve PS (see FIG. 3) the surface S1 bears on the outer surface of the wall 40 of the capsule over the section which has the increasing wall thickness, the inner protrusion R1 enters the channel 38 and the rib 28 enters the groove G. The wall thickness of the section adjacent the flange is such as to resist any inward deformation of the wall.

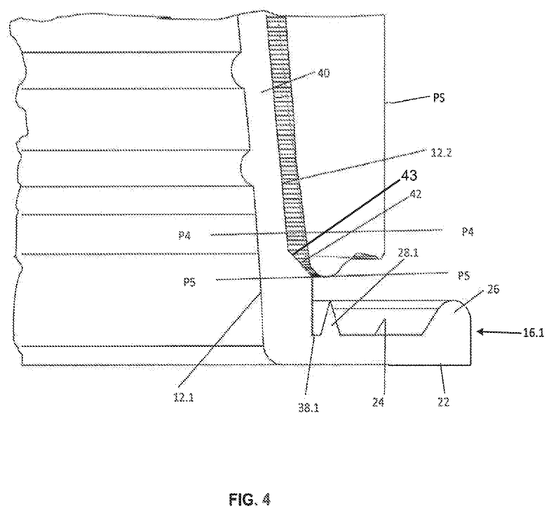

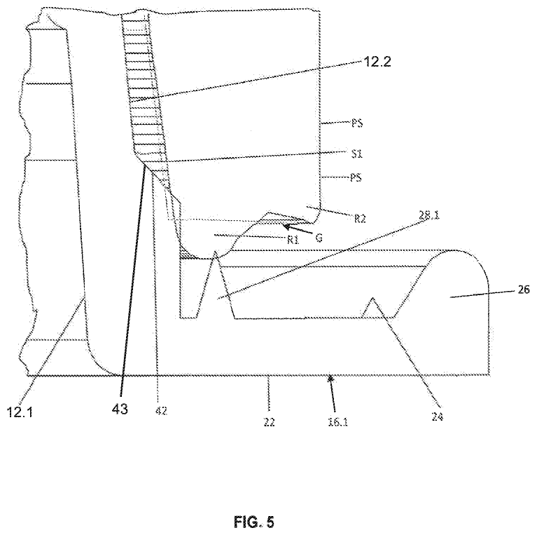

In FIGS. 4 and 5 the pressing sleeve PS and a capsule 10.1 are illustrated.

The inner and outer surfaces 12.1, 12.2 of the capsule 10.1 are of constant conical angle between the plane P4 and the smaller diameter of the capsule. At plane P4 the conical angle of the outer surface 12.2 increases sharply defining a first step, and then decreases again at plane P5 defining a second step, so as to provide a frusto-conical shoulder 42. The shoulder 42 between said steps has a circumferentially extending skew surface 43. The wall thickness of the capsule increases steadily over the extent of the shoulder 42. The part of the wall between the shoulder 42 and the bottom of the channel 38.1 is of constant thickness but is thicker than the part of the wall of the capsule between the shoulder 42 and the capsule's base. The rib 18.1 in this form is triangular in radial cross section with its base integral with the flange 16.1.

As can be seen in FIG. 5, the inner surface of the pressing sleeve PS bears on the capsule in the region of the shoulder 42, compressing the wall 40 of the capsule and forming a first radially inner sealing zone. The end of the pressing sleeve crushes the rib 28.1 thereby to form a second radially outer sealing zone.

1. A system for preparing a beverage, the system comprising:
an extraction machine comprising a pressing sleeve, the pressing sleeve comprising:
an annular leading end that defines:
a rounded inner protrusion that extends circumferentially,
an outer protrusion that extends circumferentially and is located radially outward of the inner protrusion, and
a circumferentially extending groove that is located radially between said inner and outer protrusions; and
a capsule for use in the extraction machine, the capsule comprising:
a frustoconical side wall,
a transverse base closing a smaller end of the capsule,
an open mouth at the end of the capsule remote from the transverse base, and
a peripheral flange encircling the open mouth of the capsule, a main longitudinal axis extending through a center of the capsule between the transverse base and the open mouth,
wherein a surface of the flange, which faces the transverse base, is configured to face the annular leading end of the pressing sleeve of the extraction machine into which the capsule is configured for insertion,
wherein the side wall of the capsule is thickest over a closest section thereof that is closest to the flange, there being a single circumferentially extending sealing rib protruding from said flange in a direction toward the smaller end of the capsule and a circumferentially extending channel between said sealing rib and said closest section of the side wall,
wherein a thickness of the flange at the channel is greater than the thickness of the flange between the sealing rib and an outer edge of the flange,
wherein a flange wall, which defines the circumferentially extending channel and the sealing rib, comprises a concave section in a cross-sectional view,
wherein the concave section defines a bottom of the channel,
wherein, when travelling radially inward from the bottom of the channel, said flange wall gradually curves upward and goes over from the bottom of the channel into said closest section of the side wall of the capsule,
wherein, when travelling radially outward from the bottom of the channel, said flange wall gradually curves upward from the bottom of the channel and extends toward an apex of the sealing rib, and
wherein, when the annular leading end contacts the sealing rib, the rounded inner protrusion engages the bottom of the channel and the circumferentially extending groove of the annular leading end of the pressing sleeve engages the apex of the sealing rib so as to provide a seal between the capsule and the pressing sleeve.

2. The system of claim 1, wherein:
a conical angle of an outer surface of the side wall of the capsule, over said closest section, is greater than a conical angle of an inner surface of said side wall, over said closest section,
said inner and outer surfaces diverge in a direction toward and up to the flange, and
the wall thickness increases in the direction toward and up to the flange.

3. The system of claim 1, wherein a portion of the flange wall extending to the apex of the sealing rib comprises a substantially straight sloping section, said sloping section forming a conical circumferential surface that faces inward and toward the pressing sleeve.

4. The system of claim 1, wherein, when travelling radially outward from the apex of the sealing rib, said flange wall curves downward to a substantially straight flank section, the straight flank section extending substantially parallel to the main longitudinal axis.

5. The system of claim 1, wherein a horizontal distance between the apex of the sealing rib and an outer surface of the side wall of the capsule in a direction perpendicular to the main longitudinal axis of the capsule is greater than a vertical distance parallel to said main longitudinal axis between the bottom of the channel and the apex of the sealing rib.

6. The system of claim 1, wherein the outer protrusion of the pressing sleeve is located radially outward relative to the sealing rib.

7. The system of claim 1, wherein the bottom of the channel is located radially at a same distance from the main longitudinal axis of the capsule as an apex of the inner protrusion of the pressing sleeve.

8. The system of claim 1, wherein the inner protrusion of the pressing sleeve and the bottom of the channel have a matching rounded shape.

9. The system of claim 1, wherein, in a cross-sectional view, a shape of a surface of the inner protrusion of the annular leading end matches a shape of a facing surface of the channel of the flange such that, when the annular leading end engages the flange, the surface of the inner protrusion contacts the surface of the channel to form a continuous seal that extends from the bottom of the channel to the apex of the sealing rib.

10. A system for preparing a beverage, the system comprising:
an extraction machine comprising a pressing sleeve, the pressing sleeve comprising:
an annular leading end that defines:
a rounded inner protrusion that extends circumferentially,
an outer protrusion that extends circumferentially and is located radially outward of the inner protrusion, and
a circumferentially extending groove that is located radially between said inner and outer protrusions; and
a capsule for use in the extraction machine, the capsule comprising:
a frustoconical side wall,
a transverse base closing a smaller end of the capsule,
an open mouth at the end of the capsule remote from the transverse base, and
a peripheral flange encircling the open mouth of the capsule,
wherein the side wall of the capsule is thickest over a closest section thereof that is closest to the flange, there being a single circumferentially extending sealing rib protruding from said flange in a direction towards the smaller end of the capsule and a circumferentially extending channel between said sealing rib and said closest section of the side wall,
wherein an outer surface of the side wall of the capsule has a first step in the outer surface at which a conical angle increases and a second step spaced axially toward the flange from the first step at which the conical angle decreases, thereby forming a shoulder between said first and second steps that has a circumferentially extending skew surface,
wherein the shoulder is arranged to be contacted and compressed by an inner surface of the pressing sleeve when the pressing sleeve engages the flange, the contact between the shoulder and the inner surface of the pressing sleeve forming a first seal, and
wherein the sealing rib is arranged to be contacted and compressed by the annular leading end of the pressing sleeve when the pressing sleeve engages the flange, the contact between the sealing rib and the annular leading end of the pressing sleeve forming a second seal.

11. The system of claim 10, wherein the outer surface of the capsule is cylindrical between the skew surface and the flange.

12. The system of claim 10, wherein the sealing rib has a triangular cross section, and wherein the sealing rib is integral with the flange and has an apex that is configured to be compressed by the annular leading end of the pressing sleeve.

13. The system of claim 10, wherein the outer surface of the capsule between the flange and the shoulder extends perpendicular to the flange.

14. The system of claim 10, wherein the shoulder is located at a first distance from the flange that is greater than a second distance from the flange to an apex of the sealing rib.

15. A capsule for use in an extraction machine, the capsule comprising:
a frustoconical side wall,
a transverse base closing a smaller end of the capsule,
an open mouth at an end of the capsule remote from the transverse base, and
a peripheral flange encircling the open mouth of the capsule,
wherein the side wall of the capsule is thickest over a closest section thereof that is closest to the flange, there being a single circumferentially extending sealing rib protruding from said flange in a direction towards the smaller end of the capsule and a circumferentially extending channel between said sealing rib and said closest section of the side wall,
wherein an outer surface of the side wall of the capsule has a first step in the outer surface at which a conical angle increases and a second step spaced axially toward the flange from the first step at which the conical angle decreases, thereby forming a shoulder between said steps that has a circumferentially extending skew surface,
wherein the shoulder forms a radially inner sealing zone, and the sealing rib forms a second radially outer sealing zone.
